(19) United States
(12) Patent Application Publication
(10) Pub. No.: US 2009/0240659 A1
(43) Pub. Date: Sep. 24, 2009

(54) SOCIAL NETWORKING IN A NON-PERSONALIZED ENVIRONMENT

(75) Inventors: Howard Ganz, North York (CA); Karl Joseph Borst, Toronto (CA); Jesse Scoble, Toronto (CA); Sally Christensen, Richmond Hill (CA)

Correspondence Address: Pearne & Gordon LLP, 1801 East 9th Street, Suite 1200, Cleveland, OH, 44114-3108, US

(73) Assignee: Ganz, an Ontario partnership consisting of 2121200 Ontario Inc. and 2121812 Ontario Inc., Woodbridge (CA)

(21) Appl. No.: 12/053,260

(22) Filed: Mar. 21, 2008

(30) Foreign Application Priority Data
Mar. 20, 2008 (CA) 2623188

(51) Int. Cl. G06F 17/00; G06F 17/30

(52) U.S. Cl. 707/3; 715/234; 707/E17.014

(57) ABSTRACT

A social networking website allows users to interact socially without revealing any information about themselves. The only information they reveal is about their virtual pets in the virtual website world.

### BACKGROUND

Our co-pending application Ser. No. 11/027,647, filed Dec. 30, 2004, and incorporated in its entirety herein by reference, discusses a system of interacting with a virtual representation of a real world product. According to this system, a user can buy a toy such as 100 which is associated with a special code. The toy 100 exists in the real world, and the code forms a key to the virtual world 110. The user enters the code 105 on a website and enters the virtual world 110.

The virtual world 110 provides activities and views with which the user can interact. The virtual world, as part of the interaction, provides a virtual replica 115 of the actual toy 100. Users can carry out various activities on the website using their virtual version of the toy. For example, the user can form a house with rooms, furniture, things, clothing, and other things. The user can also carry out activities to earn cash, and purchase virtual items using that cash.

### SUMMARY

The present application describes aspects of social networking on a website.

One aspect of the social networking allows displaying social network items which are not indicative of the users themselves, but rather are indicative of the users' possessions, such as their virtual pets and or other items possessed by the users. An aspect allows personalizing those items to provide even better diversity in the items that can be displayed. This allows the users to carry out social networking in an environment which is much safer than other environments in which the social networking users describe information about themselves.

Another aspect defines tools for forming the personal pages.

### BRIEF DESCRIPTION OF THE DRAWINGS

In the Drawings:

FIG. 1 shows a basic system of interacting with both a real world and virtual world items;

FIG. 2 shows a basic social networking aspect of the virtual world;

FIG. 3 shows a generic event creator;

FIG. 4 illustrates an event showcase;

FIG. 5 illustrates the basic blank page of an embodiment;

FIG. 6 illustrates how users can access the basic “my page” part of the embodiment;

FIG. 7 shows an overview of a “hub” that provides access to the various features;

FIGS. 8A and 8B show how a dynamic menu changes characteristics based on what is being accessed;

FIG. 9 shows a main search page of an embodiment;

FIGS. 10-12 show result pages from the search page;

FIG. 13 illustrates a friends list;

FIG. 14 illustrates how privacy characteristics can be set for this list;

FIG. 15 illustrates how widgets can be used to form a personalized page.

### DETAILED DESCRIPTION

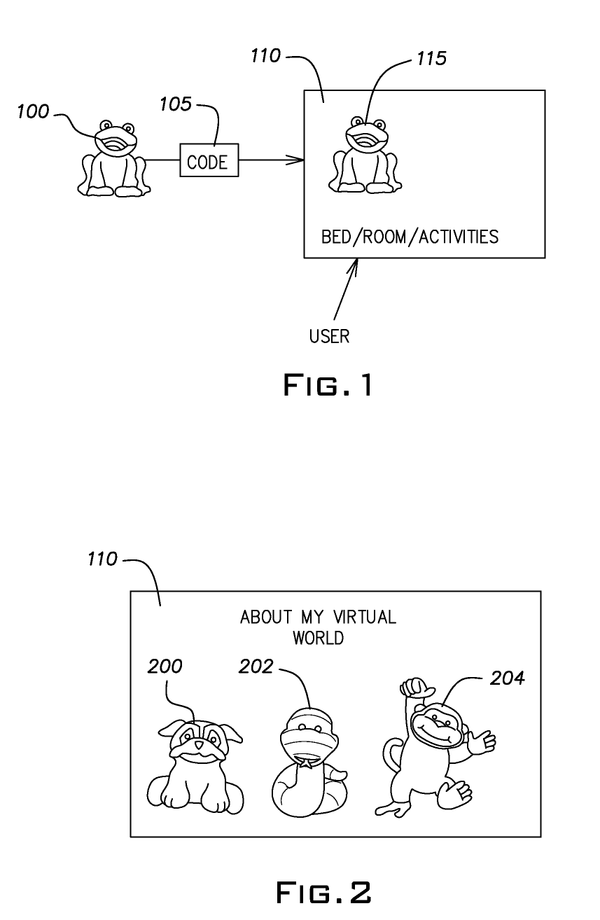

The present application describes additional aspects, actions and activities and additional structure, for adding to a website of the type described in our co-pending application, and as shown generally in FIG. 1. More specifically, the present application involves a system and method that facilitate an online social networking environment in which users interact such as, for example, by creating pages and content for the pages that relate to their respective characters rather than to personal information about the users.

Unlike conventional online social networking environments which focus on each user's personal information including personal photographs, age, gender, appearance, opinions, interests, location, and the like, the subject application allows users to socially interact by way of their particular characters. This is accomplished in part by the generation or creation of content entirely based on and around the characters' personas and virtual existences rather than the users. Thus, characters can be developed to learn and improve skills and traits and, in general, can interact with one another in a social environment without divulging users' personal information. The following figures demonstrate various aspects and embodiments of the application in greater detail.

According to FIG. 1, an item 100 is associated with a code 105. The code 105 can be entered to provide access to a website 110. The website displays a virtual replica 115 that has an appearance is recognizable as being a similar item to the item 100, responsive to the entry of the code 105. For example, the item 115 may be a cartoonized version of the item 100. The website 110 may allow a user to have a room, furniture in the room, and carry out activities in the room. As shown in FIG. 1, the user interacts with the website to provide these activities. It should be understood, however, that the aspects described herein are not limited to use with the system described in FIG. 1. These aspects can be used with other kinds of websites. For example, any website that allows user interaction can be used with this system. An embodiment describes social networking using the special website illustrated in FIG. 1.

FIG. 2 illustrates the basic structure of the embodiment. A website is formed by a number of page creation processes that each create pages based on data and desired characteristics. A virtual representation of a character 200 is shown on the website 110. The character 200, as well as other characters 202, 204, is owned by the social networking user, that is, the person who is hosting the social networking part. Each or only some of the characters may have been personalized. According to this embodiment, the characters can be trained. The training of the characters allows them to obtain and/or improve certain characteristics, such as running, etc. The training can be, however, a less formal training, in which simply interacting with the character(s) in a specified way changes the characteristic of the character.

The characters may also compete based on their characteristics. Those characters which are better trained may have the best performance in their trained characteristics. If the competition was solely about their performance as evidenced by the trained characteristics, the character with the best performance would likely win the competition.

Another aspect, however, is the aspect of creating a hybrid event.

The training may allow the user to train many different characteristics—agility, track and field, intelligence, fashion, strength, and weight lifting, as well as others. Because of the different kinds of training that can be carried out, some of the characters may be better at some trained items than others. While one character may be better at strength, another character may be better at fashion. One character may be better at swimming, and another may be better at baseball.

According to another embodiment, only a certain amount of training per day per activity is allowed, to encourage the users to return to the training site on a regular basis, e.g., every day. In this embodiment, therefore, better trained characters are better competitors. Training is limited to amounts per day, so owners who return to the site more often have better-trained characters that are likely to be more prepared for competition or better or stronger when competing.

Certain kinds of training can unlock new characteristics. For example, the character may not be allowed to swim until it has taken 20 hours of swimming lessons.

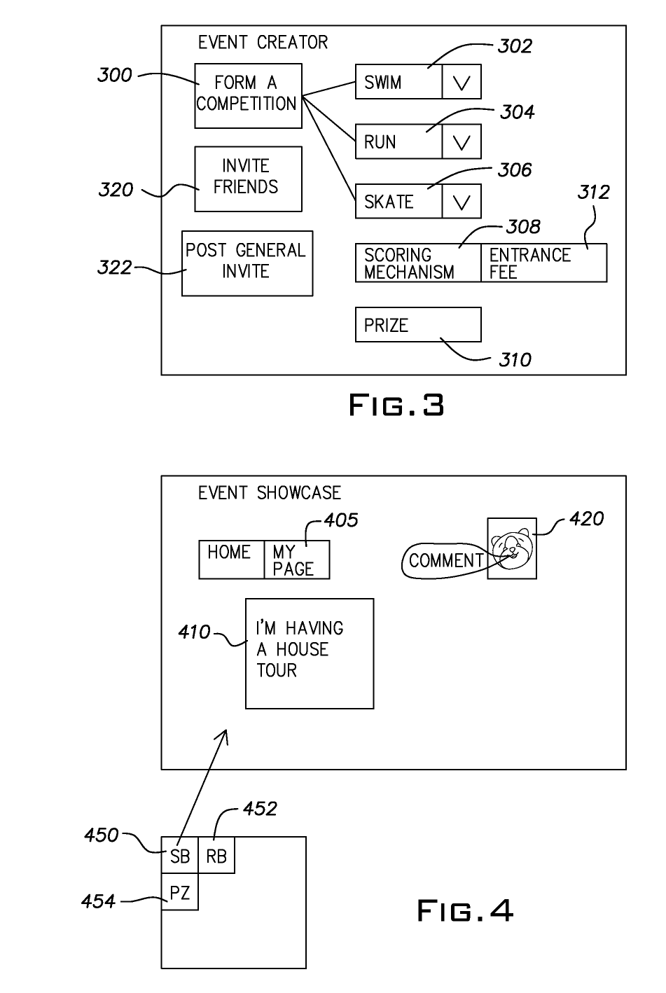

An event creator allows forming a competition as shown in FIG. 3. By executing the “form a competition” button, a number of different widgets can be displayed. The competition itself can be, for example, a hybrid triathlon formed by the widgets as shown in FIG. 3. Once having selected “form a competition” at 300, the user can select the different skills in the competition to carry out a desired competitive spirit or example. FIG. 3 shows a “forming the competition” which includes the skills of swim 302, run 304, and skate 306. The competition that is eventually formed will include these three skills.

Other people and their characters can compete in the competition. The competition may also include a “scoring mechanism” button 308, which specifies the kind of scoring that is carried out. A prize can be selected by “prize” button 310. In an embodiment, the website can allow accumulating rewards. Those rewards can be offered as a prize for the competition. For example, the event creator may use some of their virtual cash as a prize item for winning the competition, or just for competing. As an alternative, the user can purchase items, including rare items with their virtual cash, and use those purchased rare items as a prize for winning the competition. If the items are truly hard to find, they may create more of an impetus for the competition.

The user can also charge an entrance fee, for example, as a fee for joining the virtual competition. The entrance fee can be set by the user, who can enter or select a desired value as the entrance fee via a text field, list box, pull-down menu, radio buttons, or any other such data entry object, generally referred to as entrance fee object 312.

A “list box” or other suitable form field tool allowing the user to invite friends 320 can also be provided. In addition, the user can post a general invitation 322, for example in certain kinds of chat rooms, or advertise the invitation process. Different options for the general invitation can be provided.

This event creator widget, however, is just one example of a social widget: widgets that can be used to create customized social events of different types. This is a specialized form of social networking, and one that has never been previously suggested by the prior art.

According to current conventions, social networking is all about “me”—telling the world about things you have done, things you want, etc. However, this version of social networking allows a different form of social networking via events. While FIG. 3 shows the event creator being a social networking vehicle for hybrid events, other style event creation vehicles can also be used.

The social network can also be used to find new people to come to the events, and by so doing, facilitates meeting new friends within the social network. As in the above, any of the social network items can be advertised, prizes can be provided, and people can be invited.

FIG. 4 illustrates an event showcase that can be formed, for example, using one or more of the event creation widgets. The event showcase may be used to provide a special page indicative of the event, as an attempt to get other people to attend the event. In the event showcase of FIG. 4, a house tour is being hosted where the event host is providing a tour of their customized house. Different parts of the tour can be advertised on the event showcase. The event showcase may be separate, for example, from the user's personal page, and can have links 405 to their personal page. It can also have “shout boxes” that allow the user to announce their event or its attributes. Here, the shout box 410 can announce “I'm having a house tour”. Other shout boxes can analogously be selected. For example, other boxes might include “I'm showing off my pet”, or the like.

In one embodiment, one or a plurality of or all of these shout boxes may be only available with scripted messages to avoid profanities and other undesirable language or content.

A “comment wall” 420 is also provided. In this embodiment, the comment may use a virtual representation of one of the owners' virtual items as the talking head associated with the comment. As with other items in the social networking embodiment, the users can show a picture of their virtual representations instead of a picture of them personally.

In the embodiment, the event showcase can be built by a user, by taking different items such as the shout box 450, and dragging each of those on to the event showcase home page. Each box has a different function, and the user may be allowed to edit some or all of the boxes.

The shout box 450 may allow displaying a number of different messages. The room box 452 may allow setting characteristics of the site. For example, 454 is a prize box that can be edited, and may include options for awarding prizes. The price may be awarded randomly to, for example, the 17th person who attends, or it may be selected as a sweepstakes, or may be done in some other analogous way. Many different analogous controls can be used.

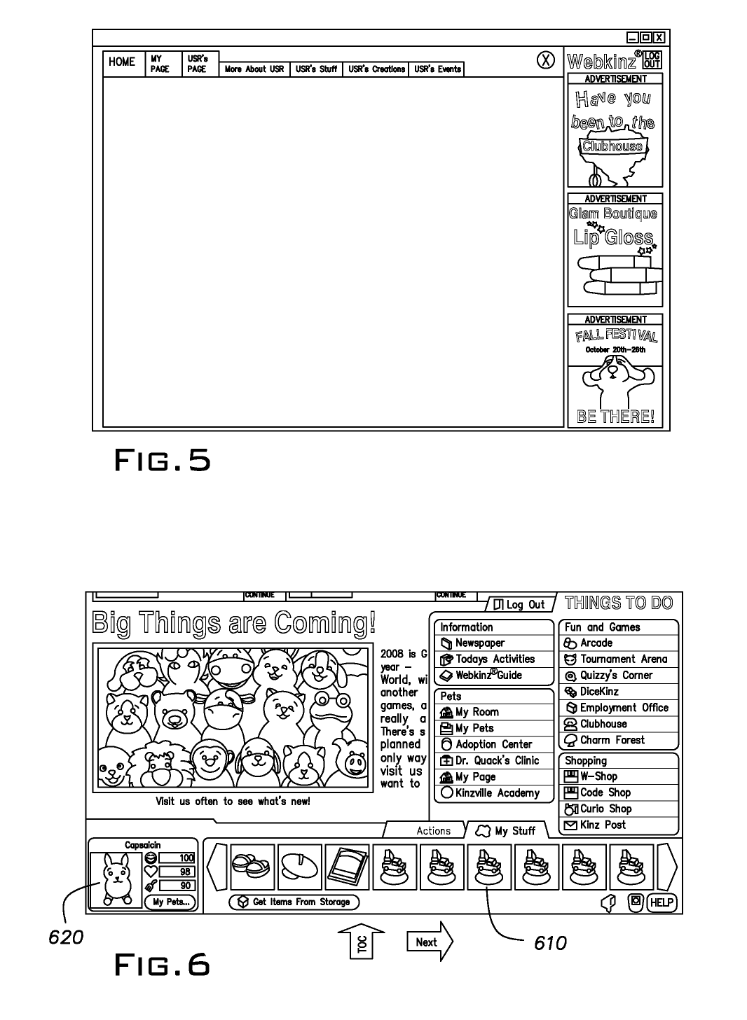

In an embodiment, the pages may be formed on a grid as shown in FIG. 5. The grid 500 forms the basis of a page in the social networking environment. The grid allows determining the placement of objects on the screen, and automatically snaps the inserted objects to the grids. This feature will ensure that layouts will be neater, while still permitting flexibility in design. Note that the page can also include tabs to navigate easily to other associated pages.

The embodiment uses a grid made up of 10px by 10px squares. All elements applied to the grid conform to the size limitations of the grid; with no half-grid pieces, e.g., no 10px by 5px pieces. The engine may add spacing around objects to ensure that a full 10px by 10px square is used.

While the grid influences placement and alignment of the objects, it still allows control over placement of those objects. On an administrative level, all objects are movable. All pages can be modified through the admin tool. From a user perspective, however, this may not be the case. Objects on the grid will be self-determined; that is, whether an object is movable or editable is a value of the object itself, and something that can be turned on or off by an administrator. So while ultimately all widgets are movable, the ability to move the widget is controlled by the user who makes the page.

A number of tools are also provided for forming the pages.

A Template provides structure for the objects on the page. Templates are used for both system-owned and user-owned pages. Some user-owned pages have the potential to have their templates changed. Templates refer strictly to the layout of the objects on the grid and do not specify any cosmetic features, such as color or font. This may include templates for various ‘canned’ functions; event pages; triathalon pages, etc.

Themes represent the cosmetic elements of a layout, including font type, font color, background colors, background images, etc. Each object has definable cosmetic features. A theme applies these changes to all of the objects simultaneously. Ultimately, users can be able to create custom themes and adjust cosmetic aspects of the objects themselves on an individual basis, not necessarily within the constraints of a theme.

A widget is a self-contained object that has various adjustable properties. These properties include where the widget exists on the page, its size, cosmetic aspects, and the content to which it is linked. Widgets exist in a display mode and in an edit mode. The widget is accessed in the edit mode, wherein editing of the page by the user is permitted. Edit mode provides customization options for the content of the widget. Cosmetic choices are also available at a later point through a Design toggle associated with the widget.

Editable Layouts provide the user with a medium to design their own layouts for the editable pages. This includes choosing the types of widgets (objects) for the page, their sizes, where they go, and what cosmetic elements are expressed on an individual element basis.

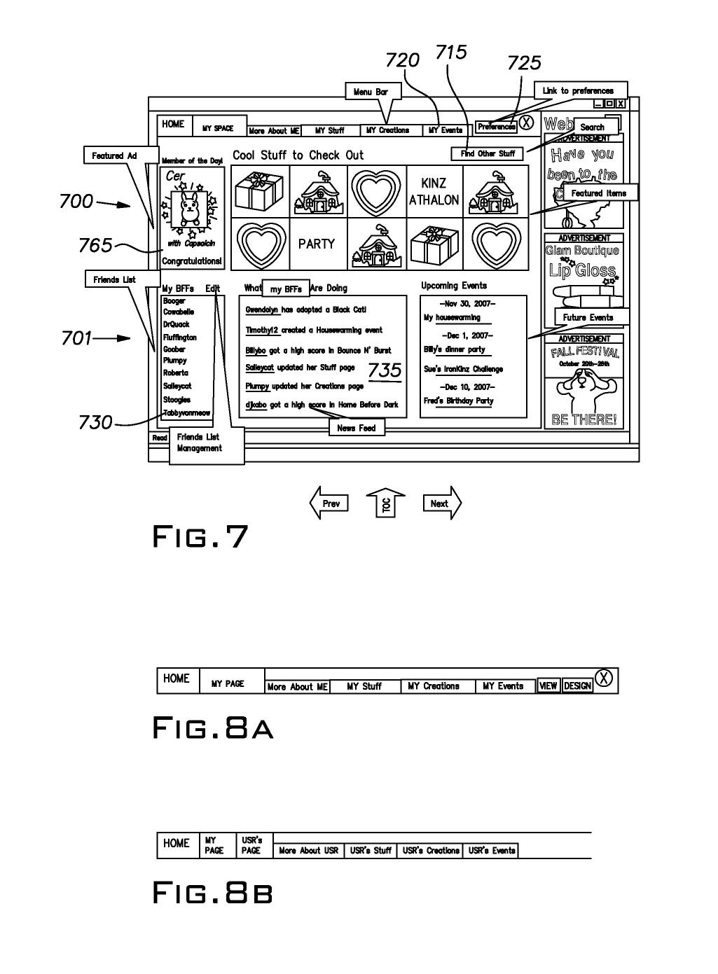

FIG. 6 shows the start page with the “stuff” bar 610, pets 620, and “things to do” bar 630. The “my page” actuation is part of the things to do menu included on the “my page” actuation shown as 600. Operating the “my page” actuation 600 brings the operator to the “hub” screen shown in FIG. 7.

FIG. 7 shows the hub of the “my page” actuation. This is the central location that introduces the users to the “my page” social networking section. Each user has their own hub, which provides the entry point for all users to their personal page(s).

The hub includes both personal information and system information via a push section 700 which provides the system generated content, and a pull section 701 which is generated based on the content of the users and their friends or, “BFFs”.

The push section of the hub includes the featured ad 705, “cool stuff to check out” 710 which may be the featured items from the system, a “search” bar 715 that allows “finding other stuff”, a “menu” bar 720, and a link to the “preferences” bar 725. Featured items are placed within the push section, e.g., in the “cool stuff” section 710.

The pull section 701 includes the friends list and its management 731, a newsfeed 735 describing actions that the best friends are doing as part of a feed, and a personalized list of upcoming events 740. As with other things on the social networking site, everything in the pull section is preferably based only on things that happen on the site. The friends are only site based friends, the newsfeed only includes actions that are occurring on the site, and the events are only events that occur on the site. Each of these is only related to an occurrence that happens on the site, thereby providing no personal information about the users.

The newsfeed content 735 is determined by selected actions of the user's best friends. The user can select who are their “best friends” (BFFs), and can also select which activities to track by newsfeed. For example, the selection can include virtual pet adoptions, game high scores, content updates, event creation(s) of friends, virtual pet birthdays, and badges and other awards earned. Note again—each of the tracked activities is based on the activities that are occurring on the website, not personal information about the user themselves.

The news items can also link to the specific user's “my page”, for example, or the more “about me” page. Each news item preferably expires after a certain time, for example after two weeks.

The menu bar 720 is a dynamic menu bar that updates depending on whether the user is visiting the hub or visiting their own page or visiting another user's page. The dynamic menu bar includes a home button, a “my page” button, a “more about me” button, and a link to “my stuff”, “my creations”, and “my events”.

According to an embodiment, the menu bar 720 changes depending on the viewed locations. FIGS. 8A and 8B respectively show the menu bars when on your own page; and when visiting another user's page. When on one's own page, as shown in FIG. 8A, the user gets tabs for “my page” and links for “me”. However, when visiting another user's page, this splits into two; to show not only your page, but also the user's page, showing more about the user, the user's “stuff” etc. In essence, the menu bar becomes dynamic, based on whether it is being used on your own page, or being used on another page.

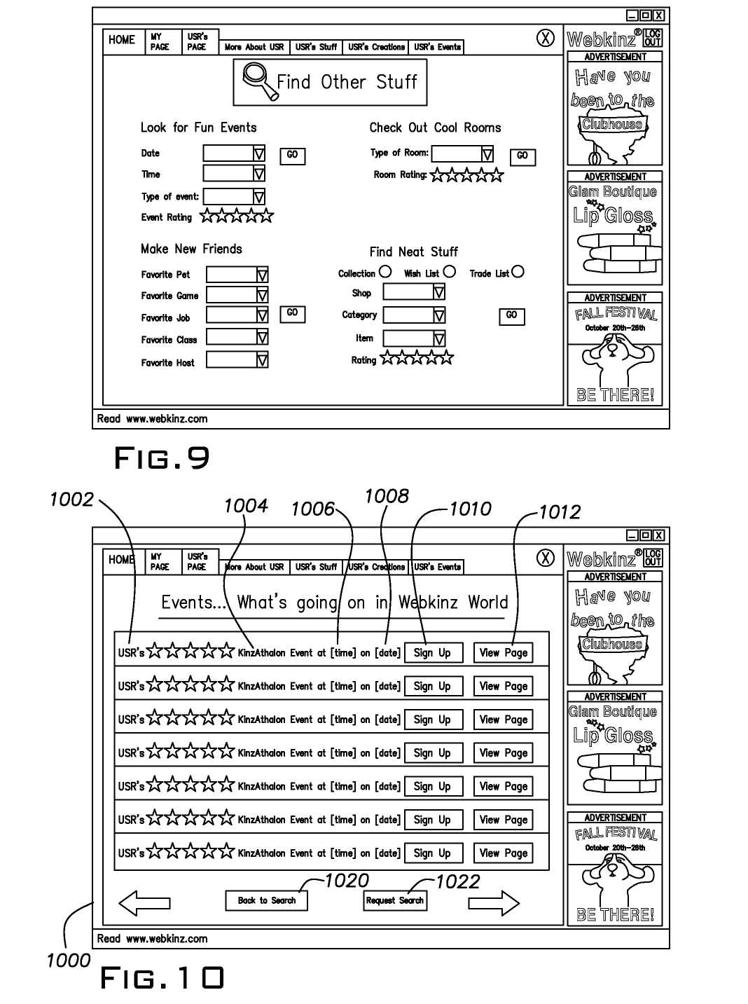

FIG. 9 illustrates how the user can carry out a search to find new friends and items for use on the virtual website. The search can be used for users to find other people to connect with. For example, this may be used for users to find other users who are not already on their friends list.

FIG. 9 illustrates how the users can look for events by date, time, type of event, and/or event rating. The users can look for rooms by type of room and room rating. Users can also use the search engine to try and make new friends, based on their favorite pet, favorite game, favorite job, favorite class, and/or favorite posts. The users can also search for virtual items. The search can be by the specific shop selling the item, by category, by item, and/or by rating.

Different searches may provide result pages. FIG. 10 illustrates an event result page 1000. The results have a user name 1002, here “USR”, a type of event 1004, here an “Kinzathalon” event which may be a selectable triathlon, time 1006, and date 1008. The user is given the chance to sign up for the event via a signup button 1010, or allowed to view the page by a view page button 102. The user can also return to the previous search to modify it, by button 1020, or to do another search by button 1022. The stars shown in FIG. 10 are determined by page viewers, e.g., by friends and visitors who rank the room design when they view it. In an embodiment, rooms inherently have no stars until ranked by at least one person. The search functionality looks for rooms ranked at a certain level. So, for example, if the search tool is set to 5 stars, only 5 star rooms will be returned.

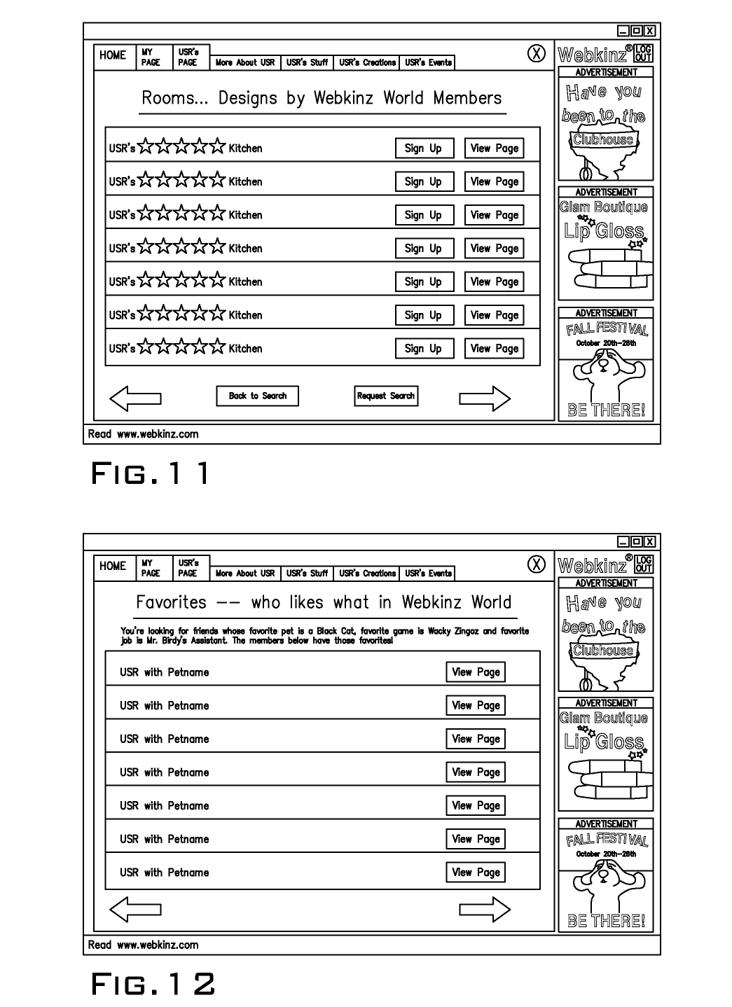

A room result may return the page shown in FIG. 11. This view shows the user, room name, and lets the user view the room and/or view the page. The room rankings as shown are based on ratings from other members.

FIG. 12 illustrates a result from the “favorite” search, returning search results of other people who have desired “likes” within the virtual world. The search results return people who have the likes and dislikes, as specified in the search.

The results are shown—here for possible new friends whose favorite pet is a black cat, favorite game is Wacky Zingoz and favorite job is Mr. Birdy's Assistant. This provides a list of users who have that same information.

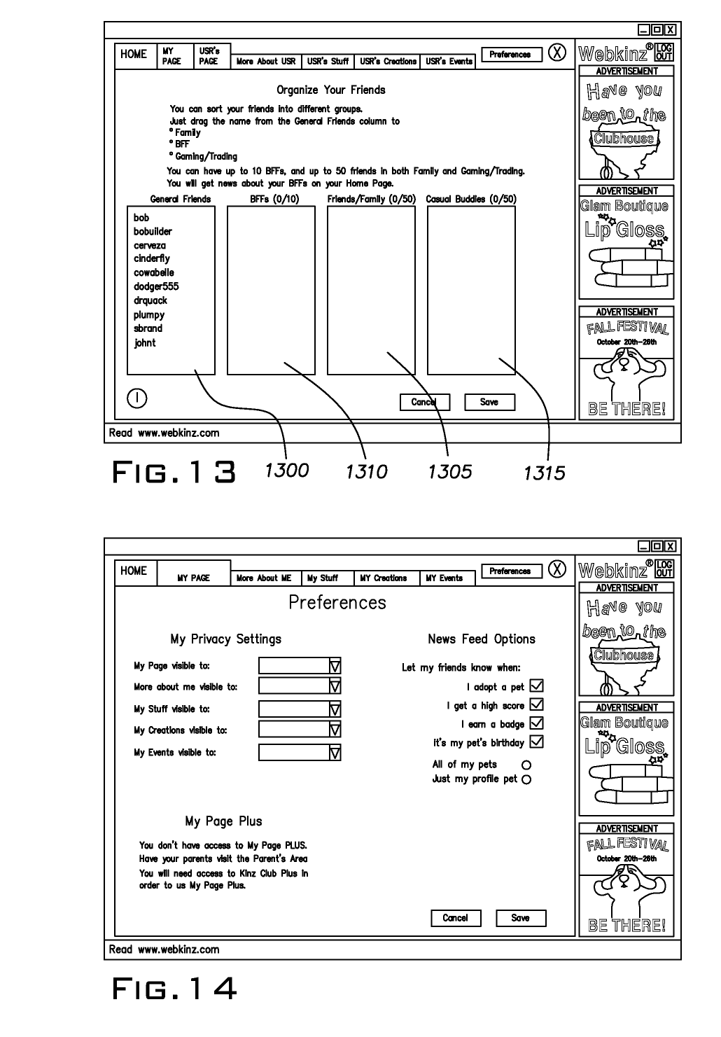

FIG. 13 shows organization of the friends list, and in particular shows how this occurs according to social networking.

The general friends are shown at the left, in field 1300. A user can drag any name from the general friends column to different sub columns; including friends/family 1305, best friends (BFFs) 1310, and casual buddies 1315.

In the embodiment, the number of best friends may be limited to some number, e.g., 20 BFFs. The user obtains information about their best friends as part of the newsfeed 735 on their homepage.

The different groups as organized into columns help determine access for various levels on the homepage. In essence, the groups stand organized in series of circles. The friends/family 1305 may be the innermost circle, then your best friends 1310, then your casual buddies 1315, and then random friends. This circle can be used as part of the privacy setting. For example, a user can set their visibility to best friends. This will allow visibility to both family and best friends. If the circle is also set to gaming and trading, then family, best friends and gaming and trading will all be included.

FIG. 14 illustrates the privacy setting capability. In FIG. 14, the user selects to whom their page is visible, to whom the “about me” is visible, as well as who else can view their “my stuff,” “my creations,” and “my events.” The circle organization allows a user to set their page to be invisible to one group of people, but visible to all classes below that one group of people. All of this is available in a drop-down menu. Another aspect shown as 1350 provides information to the friends about when different things occur. For example, this allows you to let your friends know when you adopt a pet, get a high score, earn a badge, or when your pets have a birthday. This may be done for all pets or only for some pets. The “my page plus” maybe additional information that may be available only after parents have visited the parents area.

As described above, viewability or access to a user's pages can be limited to
Family only—only friends labeled as Family can see the page;
BFFs—only friends labeled as Family and BFF can see the page;
Trading/Gaming buddies—only friends labeled as Family, BFF and Trading/Gaming buddies can see the page;
All friends—all friends on the friends list can see the page;
Everyone—everyone in the entire virtual world can see the page;
Just Me—no one, other than the owner of the page, can see the page.

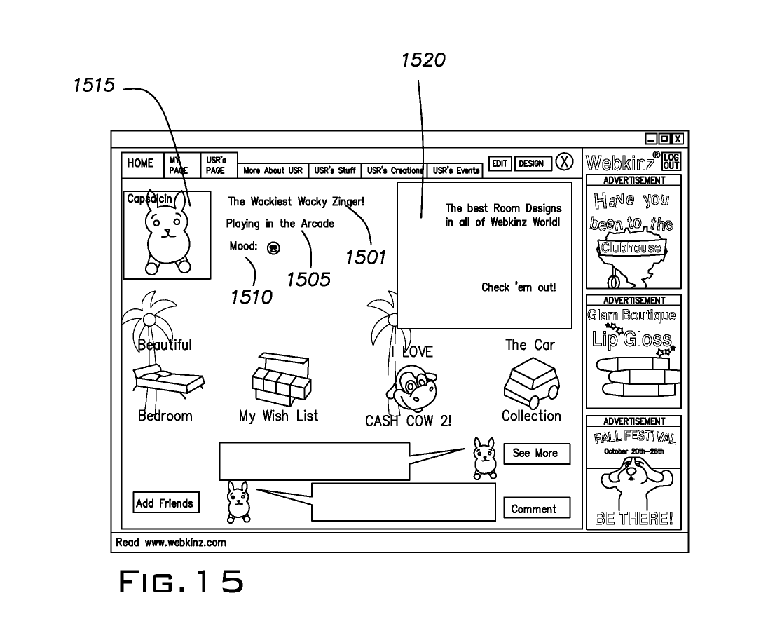

FIG. 15 illustrates the view mode for the “my page” creator. Any of the items including shout boxes, comment boxes, room design boxes, collection boxes wish list, or any other, can all be formed by widgets.

The different widgets can be created within a template, or can be dynamically placed in locations on the page as desired. When in edit mode, any of the different widgets can be selected. A widget can be edited to change its content.

The widget can be removed from edit mode and returned to view mode in which the widget can be viewed.

A tagline 1501 provides a desired phrase on the page. This can be a drop down interface allowing users to select content from a pool of available taglines, e.g., ‘canned’ lines, random lines and semi-personalized lines that are filled in with site information. Taglines will not divulge personal information of any sort, but rather use content obtained through activity on the site and through pets and feature codes.

The status widget 1505 tells the location and/or status of the user. This may allow selection of that information from a number of different possible pull-down menus. The status widget can tell a status that the user chooses to display, such as “playing in the arcade”. The user may also control this to indicate different things about what the user is doing.

A pet widget 1515 allows viewing the pet in a number of different modes, corresponding to different view modes for the pet. The pet's name may be integrated into the tag line.

The room widget 1520 shows the user's room. Pets or other items can also be selected. The user can also select their favorite item on a “favorite” widget. The user can select their mood from a number of different moods on the mood widget 1510. The default mood may be happy, but the user can select other moods. The user can also select a “welcome” widget that displays a welcome message. An item widget may display a featured item or other similar item. An “event” widget can advertise an event. A “shout box” widget allows displaying one of several different messages. An “add a comment” widget allows different people to leave comments about the site or the user. An “add-to-friends” widget allows the user to add people to their friends list. A “badges” widget allows showing the different badges that the user has. The user can also have an “other pets” widgets to show the other pets they have. A “member since” widget can be used to show how long the user has been a member. A “number of pets” widget can show how many pets the user has. The “pets favorites” widget can show the pets favorite food and the “pets birthday” widget can show the birthday. A “high score” widget can show the user's highest score. A “banner” widget may show more about the user via a banner message. Other widgets are also contemplated.

Again, this is unlike other social networking sites in that rather than showing off the user's personal information about themselves personally, this system shows off the virtual room or information and not your own (i.e., the user's) personal room or information. This system allows searching of information about virtual representations who are citizens of Webkinz World, such as the virtual representation's favorite game or favorite job, for example, that would allow identification of, or contact to be established with the user's virtual persona on the site, rather than the user him or her self. Social networking sites like Facebook® require information about yourself. The present system has no real personal information, only virtual information. In this system, unexpectedly, you show your room—again, unlike Facebook®, this is the room that you created during the rest of your site activities and hence this, not your personal information, is what you show to others. Facebook® requires you to enter information about your own activities, but the present system allows you to create the content of the website.

Special days may also be defined; e.g., triathlon day, showing off your room day, or other events or occasions. Unlike providing personal information about yourself, this system is all about the virtual world. The safeguard is inherent because this is all about the site, and all the information comes from the site. This provides users with a greater ability to express themselves and create online identities in a controlled, secure environment. It extends the social networking aspect of the site; letting users browse profiles and discover new friends, though without exposing personally identifiable information. For instance, the invite function provides the ability to allow the virtual representation belonging to the user to meet new virtual representations belonging to other people.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes certain kinds of widgets, it should be understood that other widgets can similarly be used. Moreover, this can be used on other styles and kinds of websites.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers which are used to host the website and/or to access the website may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A social networking system, comprising:
a number of page creation processes, which each create pages for users, such that each of a plurality of users have individual pages that are indicative of social characteristics, where said social characteristics that are displayed on the pages represent only content that exists within a virtual world within a website formed by the page creation processes, and do not include any personal information about the users themselves that is not specific to the website.

2. A system as in claim 1, further comprising a process that allows interacting with the characters to personalize the characters, in a way which renders the characters, once personalized, different than an original character.

3. A system as in claim 1, wherein said pages include pages indicative of competitions between virtual characters on the website.

4. A system as in claim 3, wherein said pages indicative of competitions include custom competitions in which at least one user can select multiple different events within the competition.

5. A system as in claim 2, wherein said website limits an amount of personalizing of a character that can occur in a specified time.

6. A system as in claim 4, wherein said page creation processes allow accumulating rewards on the website, where the rewards can also be offered as a prize for the competition.

7. A system as in claim 1, wherein said social characteristics include virtual representations of items that are possessed by the users in the real world.

8. A system as in claim 1, wherein said page creation processes allow creating a comments page.

9. A system as in claim 8, wherein said comments page includes a virtual representation of a virtual character used by the user who made the comment, rather than a virtual representation associated with the user itself.

10. A system as in claim 1, wherein said pages include an entry hub page, which forms an entry to said individual pages, wherein said entry hub page includes a first part formed of personalized information that is personalized according to a user's information, and a second part that includes system generated information.

11. A system as in claim 10, wherein said personalized information is based on a user selection of desired characteristics, wherein each of said characteristics represent only characteristics that are selectable on the site.

12. A system as in claim 11, wherein one of said characteristics includes a newsfeed about actions of selected friends on the website.

13. A system as in claim 1, wherein said pages include a menu bar that has a first set of tabs when the user is visiting their own page, and has a second set of tabs different than the first set of tabs when the user is visiting a friend's page.

14. A system as in claim 1, further comprising a search engine that allows users to search the website for social events and/or friends of interest.

15. A system as in claim 14, wherein said search engine allows entering desired characteristics of an event, and searches according to said desired characteristics of the event.

16. A system as in claim 14 wherein said search engine allows entering at least one specified like and/or dislike within the virtual world, and searches for users who have said specified like and/or dislike.

17. A system as in claim 1, further comprising an organizer that allows different categories of friends to see different personal information about the users.

18. A method comprising:
using a server computer to create a first personal page for a first user that includes information about the first user's possessions on a virtual world hosted within a website, and to create a second personal page for a second user that includes information about the second user's possessions on the virtual world hosted within the website, where said first and second pages are separate pages;
and where said first and second pages represent only content that exists within the virtual world of the website, and do not include any personal information about the users themselves that is not specific to the website.

19. A method as in claim 18, wherein said possessions are virtual characters on the website.

20. A method as in claim 19, further comprising interacting with the characters to personalize the characters, in a way which renders the characters, once personalized, different than an original character, and wherein said virtual characters on the website that are shown on said personal pages include said personalized characters.

21. A method as in claim 20, further comprising defining custom competitions in which at least one user can select multiple different events within the competition.

22. A method as in claim 20, further comprising limiting an amount of personalizing of a character that can occur in a specified time.

23. A method as in claim 22, wherein said limiting comprises limiting an amount of personalizing that can occur each day.

24. A method as in claim 21, further comprising allowing accumulating rewards on the website, and keeping track of the accumulated rewards, and allowing offering parts of the rewards as a prize for the competition.

25. A method as in claim 19, wherein said virtual characters are representations of items that are possessed by the users in the real world.

26. A method as in claim 25, wherein said page creation processes allow creating a comments page.

27. A method as in claim 25, wherein said comments page includes a virtual representation of a virtual character used by the user who made the comment, rather than a virtual representation associated with the user itself.

28. A method as in claim 18, further comprising using said server computer to create an entry hub page, which forms an entry to said personal pages, wherein said entry hub page includes a first part formed of user information that is based on said user's possessions, and said entry hub page also includes a second part that includes system generated information.

29. A method as in claim 28, wherein said user information is based on a user selection of desired characteristics, wherein each of said characteristics represent only characteristics that are selectable on the site.

30. A method as in claim 29, wherein one of said characteristics includes a newsfeed about actions of selected friends on the website.

31. A method as in claim 18, wherein said first and second pages include a menu bar that has a first set of tabs when the user is visiting their own page, and has a second set of tabs different than the first set of tabs when the user is visiting a friend's page.

32. A method as in claim 18, further comprising using said server computer to create a search engine that allows users to search the website for social events and/or friends of interest.

33. A method as in claim 32, wherein said search engine allows entering desired characteristics of an event, and searches according to said desired characteristics of the event.

34. A method as in claim 32 wherein said search engine allows entering at least one specified like and/or dislike within the virtual world, and searches for users who have said specified like and/or dislike.

35. A method as in claim 18, further comprising an organizer that allows different categories of friends to see different personal information about the users.

36. A system for presenting a social networking website, said system comprising:
means for executing a plurality of page creation processes, each one of said page creation processes for enabling each one of a plurality of users to generate individual pages that are indicative of certain social characteristics, wherein said certain social characteristics that are displayed on the pages represent content that exists within the virtual world of the website, said content not including information for identifying the actual identity of the users, and wherein
each one of said page creation processes is for generating individual pages that are indicative of a different certain social characteristic than another one of said page creation processes.
